(19) United States
(12) Patent Application Publication
(10) Pub. No.: US 2016/0032881 A1
(43) Pub. Date: Feb. 4, 2016

(54) VEHICULAR POWER TRANSMISSION DEVICE

(71) Applicant: HONDA MOTOR CO., LTD., Tokyo (JP)

(72) Inventors: Kazuki Ichikawa, Wako-shi (JP); Yuji Nishimura, Wako-shi (JP); Tsunehiro Kobayashi, Wako-shi (JP)

(73) Assignee: HONDA MOTOR CO., LTD., Tokyo (JP)

(21) Appl. No.: 14/781,339

(22) PCT Filed: Mar. 5, 2014
(86) PCT No.: PCT/JP2014/055612

§ 371 Date: Sep. 30, 2015

(30) Foreign Application Priority Data
Apr. 1, 2013 (JP) 2013-076169

(51) Int. Cl. F02N 11/08; F16H 29/04

(52) U.S. Cl. CPC F02N 11/0818; F16H 29/04

(57) ABSTRACT

A vehicular power transmission including a crank type continuously variable transmission is provided in which when the rotational speed of an engine during deceleration fuel cut-off is at least a first rotational speed, which is an upper limit of rotational speed at which plunging of a starter motor is possible, but less than a second rotational speed, which is a lower limit of rotational speed at which self-ignition of the engine is possible. The engine is cranked and restarted by transmitting the driving force of an electric motor of a shift actuator to an input shaft via first and second engagement portions. This eliminates the need for restarting the engine with the starter motor by waiting until the rotational speed of the engine has become less than the first rotational speed, thus reducing the time required for restarting the engine. Moreover, the electric motor can be made small.

### TECHNICAL FIELD

The present invention relates to a vehicular power transmission device that enables an engine to be restarted during deceleration fuel cut-off by utilizing an electric motor for driving a shift actuator.

### BACKGROUND ART

A crank type continuously variable transmission that converts rotation of an input shaft connected to an engine into back-and-forth movements, having different phases from each other, of a plurality of connecting rods, and converts the back-and-forth movement of the plurality of connecting rods into rotation of an output shaft by a plurality of one-way clutches is known from Patent Document 1 below.

### RELATED ART DOCUMENTS

### Patent Documents

Patent Document 1: Japanese Patent Publication No. 2005-502543

### SUMMARY OF THE INVENTION

### Problems to be Solved by the Invention

In a vehicle that carries out deceleration fuel cut-off, in which the supply of fuel is cut off when the vehicle is decelerating, it is necessary to restart the engine during deceleration fuel cut-off when the driver intends to accelerate. At the time that restarting becomes necessary, if the rotational speed of the engine, which is idling with a driving force that is transmitted back from a driven wheel, is at least the rotational speed at which self-ignition is possible, the engine can be restarted simply by restarting the supply of fuel, but if the rotational speed of the engine is less than the rotational speed at which self-ignition is possible, it is necessary to drive a starter motor to thus restart the engine by cranking.

As the starter motor for the engine, a known plunge type starter motor is usually employed. This plunge type starter motor includes a ring gear that rotates integrally with a crankshaft and a pinion that is driven by the motor and can mesh with the ring gear; when the motor is not in operation the pinion moves back in the axial direction, and when the motor is in operation the pinion moves forward in the axial direction and plunges into a position at which it meshes with the ring gear. However, since the plunge type starter motor has characteristics such that when the engine rotational speed is at least the upper limit of rotational speed at which plunging is possible, the pinion becomes incapable of meshing with the ring gear, if the rotational speed of the engine during deceleration fuel cut-off is less than the rotational speed at which self-ignition is possible and at least the upper limit of rotational speed at which plunging is possible, it becomes necessary to drive the starter motor by waiting until the rotational speed of the engine has decreased to less than the upper limit of rotational speed at which plunging is possible, and there is the problem that restarting of the engine is delayed by a period of time corresponding to the above.

The present invention has been accomplished in light of the above circumstances, and it is an object thereof to provide a vehicular power transmission device including a crank type continuously variable transmission that enables an engine to be restarted quickly during deceleration fuel cut-off.

### Means for Solving the Problems

In order to attain the above object, according to a first aspect of the present invention, there is provided a vehicular power transmission device comprising an input shaft that is connected to an engine having a plunge type starter motor, an output shaft that is disposed in parallel to the input shaft, a swinging link that is swingably supported on the output shaft, a one-way clutch that is disposed between the output shaft and the swinging link, and that is engaged when the swinging link swings in one direction, and that releases engagement when the swinging link swings in the other direction, an eccentric member that rotates eccentrically integrally with the input shaft, a gear shaft that is disposed coaxially with the input shaft and changes an amount of eccentricity of the eccentric member, a shift actuator that makes the gear shaft rotate relative to the input shaft, an electric motor that drives the shift actuator, and a connecting rod that connects the eccentric member and the swinging link, wherein the shift actuator comprises a first member that is connected to the input shaft, a second member that is connected to the gear shaft, a third member that is connected to the electric motor and that drives the first and second members at different rotational speeds, and engagement portions that engage with each other when the first and second members are in a predetermined phase and that are capable of transmitting rotation of the second member directly to the first member, when the rotational speed of the engine during deceleration fuel cut-off is less than a first rotational speed, which is an upper limit of rotational speed at which plunging of the starter motor is possible, the engine is restarted by driving the starter motor, when the rotational speed of the engine during deceleration fuel cut-off is at least a second rotational speed, which is a lower limit of rotational speed at which self-ignition of the engine is possible, the engine is restarted by restarting fuel injection, and when the rotational speed of the engine during deceleration fuel cut-off is at least the first rotational speed but less than the second rotational speed, the engine is restarted by transmitting the driving force of the electric motor to the input shaft via the engagement portion.

Further, according to a second aspect of the present invention, in addition to the first aspect, when the rotational speed of the engine during deceleration fuel cut-off is at least the first rotational speed but less than the second rotational speed, the rotational speed of the engine is increased to at least the second rotational speed by the driving force of the electric motor.

Furthermore, according to a third aspect of the present invention, in addition to the first or second aspect, the amount of eccentricity of the eccentric member when the engagement portion engages is zero.

An eccentric disk 19 of an embodiment corresponds to the eccentric member of the present invention, a sun gear 28 of the embodiment corresponds to the third member of the present invention, a first ring gear 30 of the embodiment corresponds to the first member of the present invention, a second ring gear 31 of the embodiment corresponds to the second member of the present invention, a first engagement portion 43a and a second engagement portion 44a of the embodiment correspond to the engagement portion of the present invention, an upper limit of rotational speed at which plunging is possible of the embodiment corresponds to the first rotational speed of the present invention, and a lower limit of rotational speed at which self-ignition is possible of the embodiment corresponds to the second rotational speed.

### Effects of the Invention

In accordance with the first aspect of the present invention, when the input shaft connected to the engine rotates, the eccentric member rotates eccentrically integrally with the input shaft, the connecting rod having one end connected to the eccentric member moves back-and-forth, and the swinging link connected to the other end of the connecting rod swings back-and-forth. When the swinging link swings in one direction the one-way clutch is engaged, and when the swinging link swings in the other direction the one-way clutch releases the engagement, rotation of the input shaft thus being changed in speed and transmitted to the output shaft. When the shift actuator is driven by the electric motor to thus rotate the gear shaft relative to the input shaft, the amount of eccentricity of the eccentric member changes, the back-and-forth stroke of the connecting rod changes, and the gear ratio of the power transmission device is changed.

When the third member of the shift actuator is rotatingly driven by the electric motor, the first member connected to the input shaft and the second member connected to the gear shaft are driven at different rotational speeds; when the relative rotational angle between the first and second members becomes a predetermined value or greater, the engagement portion is engaged, and the input shaft and the gear shaft are rotatingly driven by the driving force of the electric motor. This enables the engine connected to the input shaft to be cranked by means of the driving force of the electric motor.

When the rotational speed of the engine during deceleration fuel cut-off is less than the first rotational speed, which is the upper limit of rotational speed at which plunging of the starter motor is possible, the engine can be restarted by driving the starter motor. When the rotational speed of the engine during deceleration fuel cut-off is at least the second rotational speed, which is the lower limit of rotational speed at which self-ignition of the engine is possible, the engine can be restarted simply by restarting fuel injection without specially cranking the engine. When the rotational speed of the engine during deceleration fuel cut-off is at least the first rotational speed but less than the second rotational speed, although neither restarting with the starter motor nor restarting with self-ignition are possible, transmitting the driving force of the electric motor to the input shaft via the engagement portion enables the engine to be restarted by cranking.

This eliminates the need for restarting the engine with the starter motor by waiting until the rotational speed of the engine has become less than the first rotational speed, which is the upper limit of rotational speed at which plunging of the starter motor is possible, and it becomes possible to restart the engine by cranking with the electric motor of the shift actuator from a state in which the rotational speed of the engine is less than the first rotational speed, thus reducing the time required for restarting the engine. Moreover, since the electric motor need only have an output that can increase the rotational speed of the engine, the electric motor can be made small.

Furthermore, in accordance with the second aspect of the present invention, if the rotational speed of the engine during deceleration fuel cut-off is at least the first rotational speed but less than the second rotational speed, since the rotational speed of the engine is increased to at least the second rotational speed by means of the driving force of the electric motor, it is possible to reliably restart the engine with only the driving force of the electric motor.

Moreover, in accordance with the third aspect of the present invention, since the amount of eccentricity of the eccentric member when the engagement portion engages is zero, not only does the friction of each section of the power transmission device become small to thus reduce the load of the electric motor, but the gear ratio of the power transmission device when the engine is restarted also becomes infinite, and it is possible to prevent the driving force of the engine from being unexpectedly transmitted to the driven wheel.

### BRIEF DESCRIPTION OF DRAWINGS

FIG. 1 is an overall perspective view of a continuously variable transmission. (first embodiment)

FIG. 2 is a partially cutaway perspective view of an essential part of the continuously variable transmission. (first embodiment)

FIG. 3 is a sectional view along line 3-3 in FIG. 1. (first embodiment)

FIG. 4 is an enlarged view of part 4 in FIG. 3. (first embodiment)

FIG. 5 is a sectional view along line 5-5 in FIG. 3. (first embodiment)

FIG. 6 is a diagram showing the shape of an eccentric disk. (first embodiment)

FIG. 7 is a diagram showing the relationship between the amount of eccentricity of the eccentric disk and gear ratio. (first embodiment)

FIG. 8 is a diagram showing the state of the eccentric disk in a OD gear ratio and an UD gear ratio. (first embodiment)

FIG. 9 is a sectional view along line 9-9 in FIG. 4. (first embodiment)

FIG. 10 is a flowchart of engine restarting. (first embodiment)

FIG. 11 is a time chart of engine restarting. (first embodiment)

### EXPLANATION OF REFERENCE NUMERALS AND SYMBOLS

12 Input shaft

13 Output shaft

15 Gear shaft

19 Eccentric disk (eccentric member)

23 Shift actuator

24 Electric motor

28 Sun gear (third member)

30 First ring gear (first member)

31 Second ring gear (second member)

33 Connecting rod

36 One-way clutch

42 Swinging link

43a First engagement portion (engagement portion)

44a Second engagement portion (engagement portion)

E Engine

S Starter motor

### MODE FOR CARRYING OUT THE INVENTION

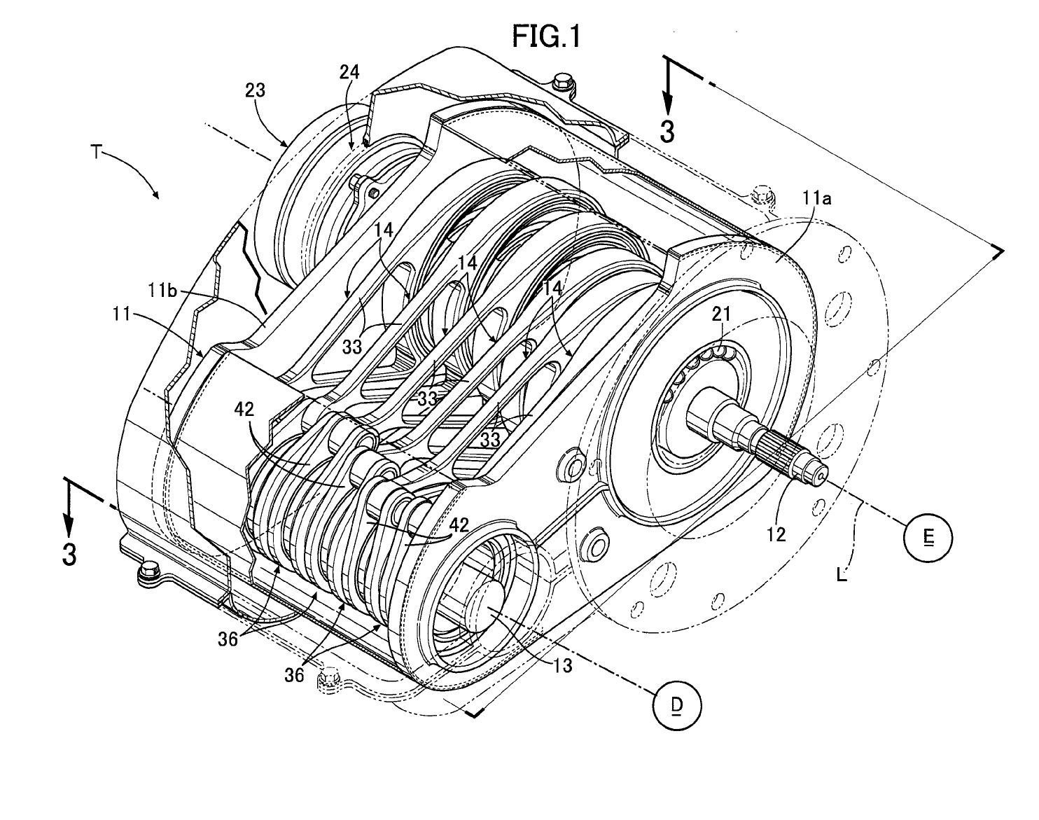

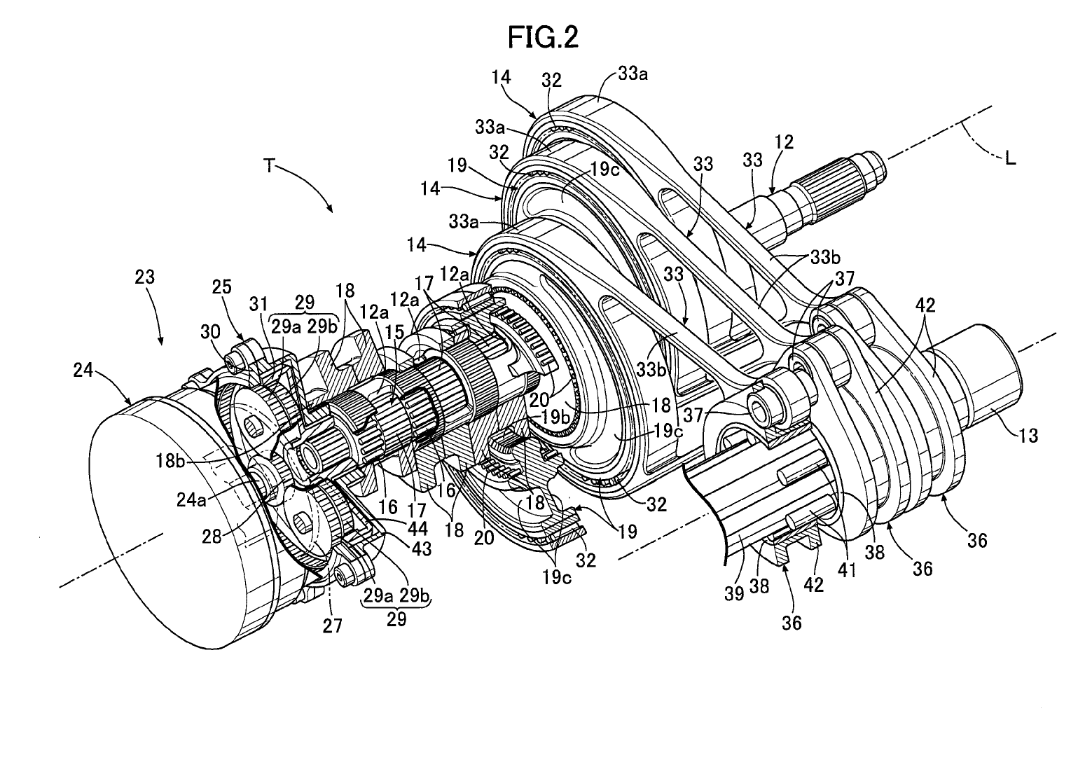

An embodiment of the present invention is explained below by reference to FIG. 1 to FIG. 11.

### First Embodiment

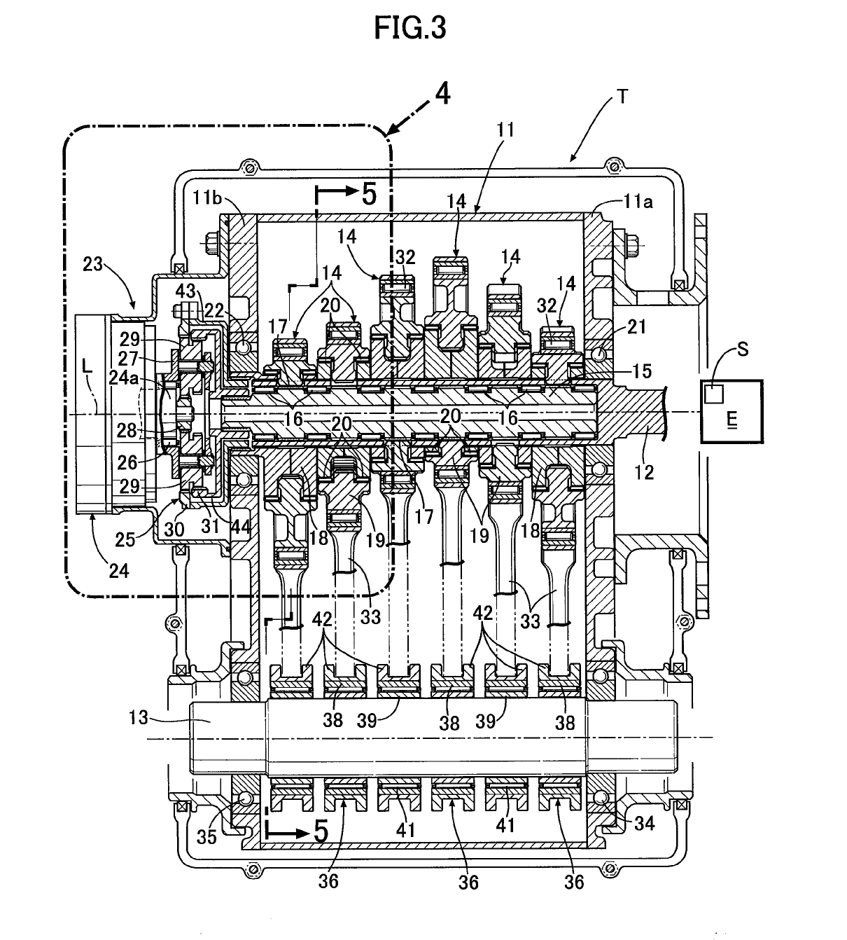

As shown in FIG. 1 to FIG. 5, an input shaft 12 and an output shaft 13 are supported on a pair of side walls 11a and 11b of a transmission case 11 of a continuously variable transmission T for an automobile so as to be parallel to each other, and rotation of the input shaft 12 connected to an engine E is transmitted to a driven wheel via six transmission units 14, the output shaft 13, and a differential gear D. The engine E is provided with a starter motor S (see FIG. 3) for cranking its crankshaft to thus start it. The starter motor S is a known plunge type and includes a ring gear that rotates integrally with the crankshaft and a pinion that is driven by the motor and can mesh with the ring gear. When the motor is not in operation the pinion moves back in the axial direction, and when the motor is in operation the pinion moves forward in the axial direction and plunges into a position at which it meshes with the ring gear, thus cranking the crankshaft.

A transmission shaft 15 having a common axis L with the input shaft 12 is relatively rotatably fitted into the interior of the input shaft 12, which is hollow, via seven needle bearings 16. Since the structures of the six transmission units 14 are substantially identical, the structure of one transmission unit 14 is explained below as being representative thereof.

The transmission unit 14 includes a pinion 17 provided on an outer peripheral face of the transmission shaft 15, and this pinion 17 is exposed through an opening 12a formed in the input shaft 12. A disk-shaped eccentric cam 18, which is split into two in the axis L direction, is spline-joined to the outer periphery of the input shaft 12 so as to sandwich the pinion 17. A center O1 of the eccentric cam 18 is eccentric to the axis L of the input shaft 12 only by a distance d. The phases in the direction of eccentricity of the six eccentric cams 18 of the six transmission units 14 are displaced from each other by 60°.

A pair of eccentric recess portions 19a and 19a formed in opposite end faces in the axis L direction of a disk-shaped eccentric disk 19 are rotatably supported on an outer peripheral face of the eccentric cam 18 via a pair of needle bearings 20 and 20. The center O1 of the eccentric recess portions 19a and 19a (that is, the center O1 of the eccentric cam 18) is displaced only by the distance d with respect to a center O2 of the eccentric disk 19. That is, the distance d between the axis L of the input shaft 12 and the center O1 of the eccentric cam 18 is identical to the distance d between the center O1 of the eccentric cam 18 and the center O2 of the eccentric disk 19.

A pair of crescent-shaped guide portions 18a and 18a, which are coaxial with the center O1 of the eccentric cam 18, are provided on split faces of the eccentric cam 18, which is split into two in the axis L direction, and the extremities of teeth of a ring gear 19b formed so as to provide communication between bottom parts of the pair of eccentric recess portions 19a and 19a of the eccentric disk 19 abut slidably against outer peripheral faces of the guide portions 18a and 18a of the eccentric cam 18. The pinion 17 of the transmission shaft 15 meshes with the ring gear 19b of the eccentric disk 19 through the opening 12a of the input shaft 12.

The right end side of the input shaft 12 is directly supported on the right-hand side wall 11a of the transmission case 11 via a ball bearing 21. Furthermore, a tubular portion 18b provided integrally with one eccentric cam 18 positioned on the left end side of the input shaft 12 is supported on the left-hand side wall 11b of the transmission case 11 via a ball bearing 22, and the left end side of the input shaft 12 spline-joined to the inner periphery of the eccentric cam 18 is indirectly supported on the transmission case 11.

A transmission actuator 23 that varies the gear ratio of the continuously variable transmission T by rotating the transmission shaft 15 relative to the input shaft 12 includes an electric motor 24 supported on the transmission case 11 so that a motor shaft 24a is coaxial with the axis L, and a planetary gear mechanism 25 connected to the electric motor 24. The planetary gear mechanism 25 includes a carrier 27 rotatably supported on the electric motor 24 via a needle bearing 26, a sun gear 28 fixed to the motor shaft 24a, a plurality of double pinions 29 rotatably supported on the carrier 27, a first ring gear 30 provided on a first connecting member 43 spline-joined to the shaft end of the hollow input shaft 12 (strictly speaking, the tubular portion 18b of the one eccentric cam 18), and a second ring gear 31 provided on a second connecting member 44 spline-joined to the shaft end of the transmission shaft 15. Each double pinion 29 includes a large diameter first pinion 29a and a small diameter second pinion 29b, the first pinion 29a meshing with the sun gear 28 and the first ring gear 30, and the second pinion 29b meshing with the second ring gear 31.

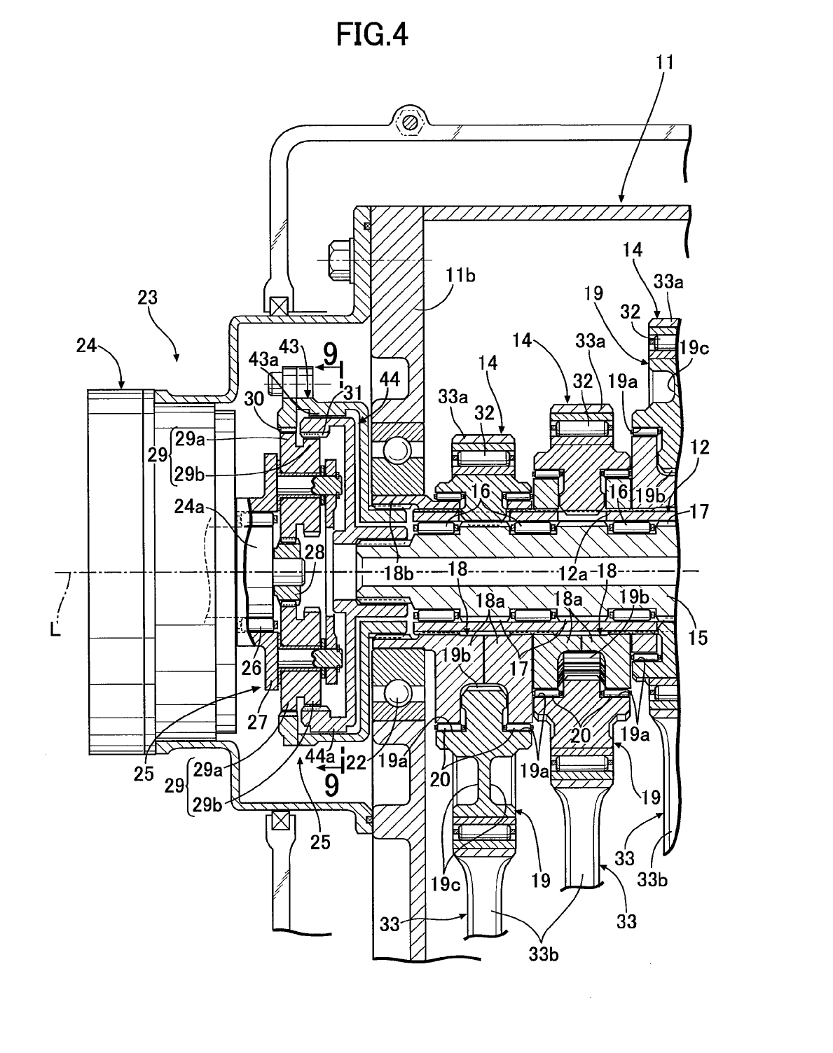

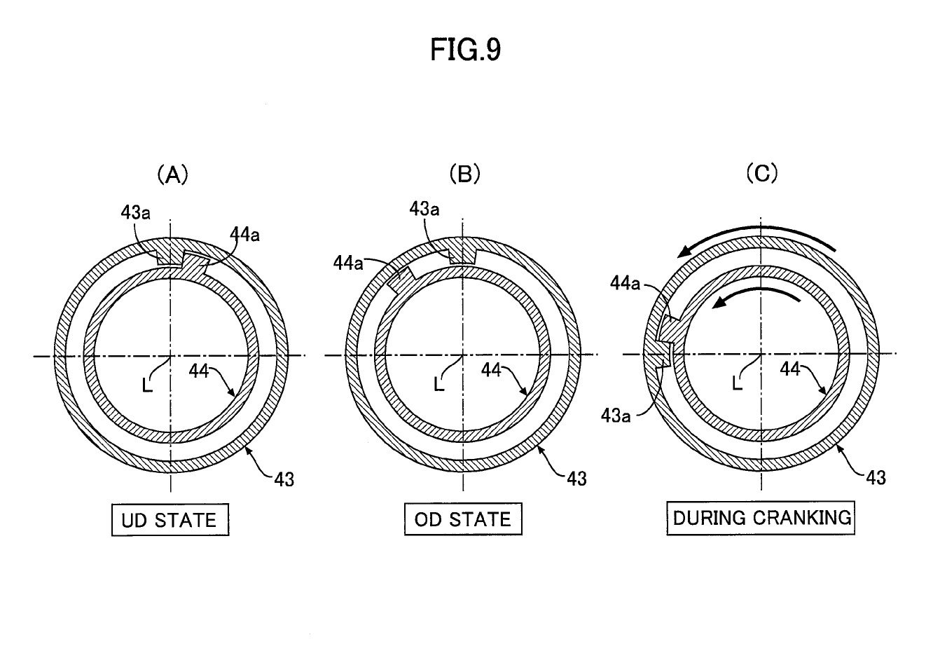

An annular outer peripheral part of the first connecting member 43 and an annular outer peripheral part of the second connecting member 44 oppose each other in the radial direction (see FIG. 4 and FIG. 9), a first engagement portion 43a is radially inwardly projectingly provided on an inner peripheral face of the first connecting member 43 on the radially outer side, and a second engagement portion 44a is radially outwardly projectingly provided on an outer peripheral face of the second connecting member 44 on the radially inner side. When the amount of eccentricity of the eccentric disk 19 of the transmission unit 14 is zero, that is, when the gear ratio of the continuously variable transmission T is UD, the first engagement portion 43a and the second engagement portion 44a abut against each other (see FIG. 9(A)). When the amount of eccentricity of the eccentric disk 19 of the transmission unit 14 increases from zero and the gear ratio of the continuously variable transmission T changes from UD toward OD, the second engagement portion 44a undergoes relative rotation in the clockwise direction in the figure with respect to the first engagement portion 43a, and when the gear ratio of the continuously variable transmission T reaches OD, the difference in phase between the first engagement portion 43a and the second engagement portion 44a becomes a maximum (see FIG. 9(B)).

An annular portion 33a on one end side of a connecting rod 33 is relatively rotatably supported on the outer periphery of the eccentric disk 19 via a roller bearing 32.

The output shaft 13 is supported on the pair of side walls 11a and 11b of the transmission case 11 by means of a pair of ball bearings 34 and 35, a swinging link 42 is supported on the outer periphery of the output shaft 13 via a one-way clutch 36, and the extremity of the swinging link 42 is pivotably supported on the extremity of a rod portion 33b of the connecting rod 33 via a pin 37. The one-way clutch 36 includes a ring-shaped outer member 38 press fitted into the inner periphery of the swinging link 42, an inner member 39 disposed in the interior of the outer member 38 and fixed to the output shaft 13, and a plurality of rollers 41 disposed in a wedge-shaped space formed between an arc face on the inner periphery of the outer member 38 and a flat face on the outer periphery of the inner member 39 and urged by a plurality of springs 40.

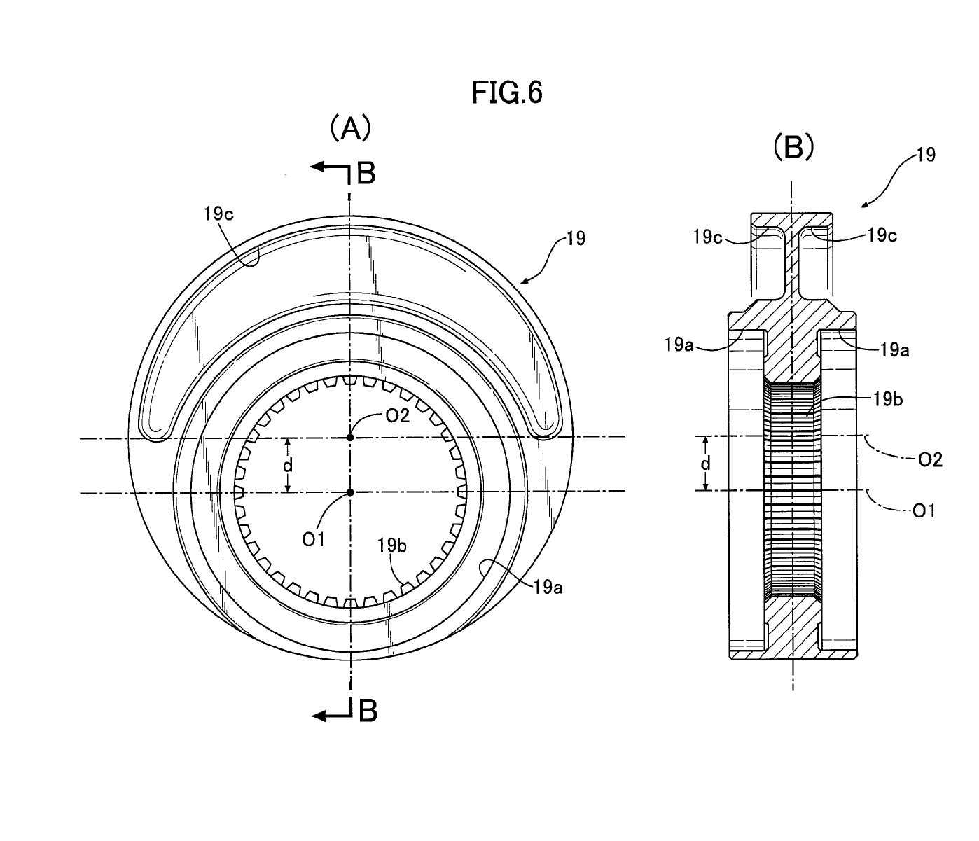

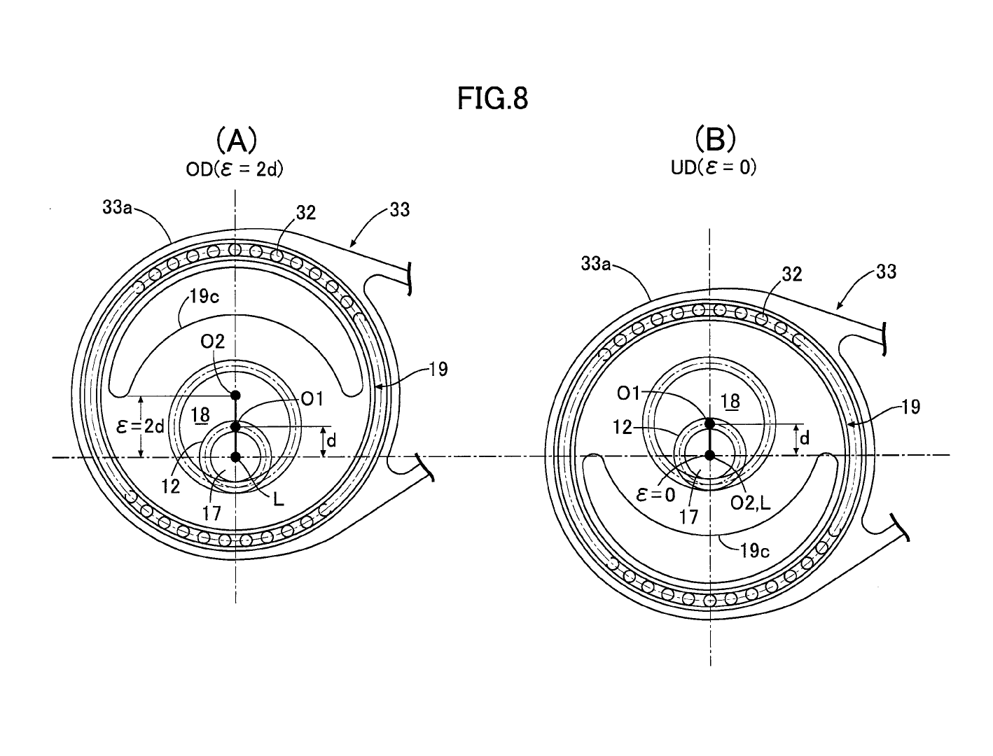

As shown in FIG. 6 and FIG. 8, the center O1 of the eccentric recess portions 19a and 19a (that is, the center O1 of the eccentric cam 18) is displaced by the distance d with respect to the center O2 of the eccentric disk 19, the gap between the outer periphery of the eccentric disk 19 and the inner periphery of the eccentric recess portions 19a and 19a is non-uniform in the circumferential direction, and crescent-shaped cutout recess portions 19c and 19c are formed in a section where the gap is large.

The operation of one transmission unit 14 of the continuously variable transmission T is now explained.

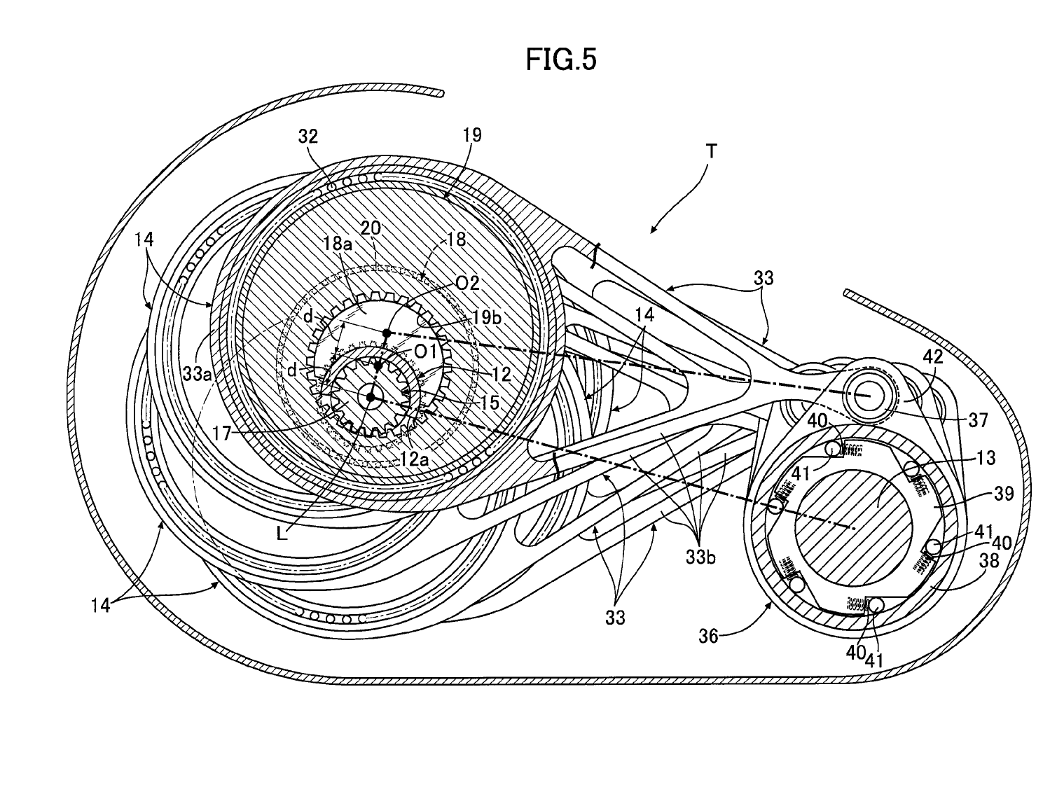

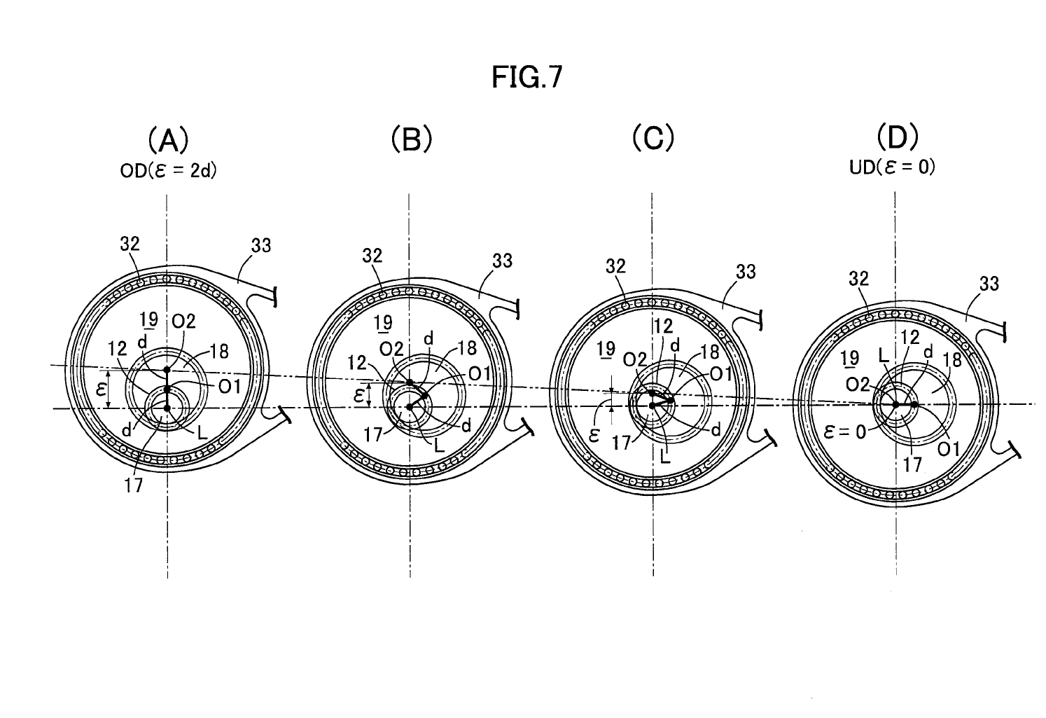

As is clear from FIG. 5 and FIG. 7(A) to FIG. 7(D), if the center O2 of the eccentric disk 19 is eccentric with respect to the axis L of the input shaft 12, when the input shaft 12 is rotated by the engine E, the annular portion 33a of the connecting rod 33 rotates eccentrically around the axis L, and the rod portion 33b of the connecting rod 33 moves back-and-forth.

As a result, when the connecting rod 33 is pulled leftward in the figure in the process of moving back-and-forth, the rollers 41 urged by the springs 40 bite into the wedge-shaped spaces between the outer member 38 and the inner member 39; due to the outer member 38 and the inner member 39 being joined via the rollers 41, the one-way clutch 36 is engaged, and movement of the connecting rod 33 is transmitted to the output shaft 13. On the other hand, when the connecting rod 33 is pushed rightward in the figure during the process of moving back-and-forth, the rollers 41 are pushed out from the wedge-shaped spaces between the outer member 38 and the inner member 39 while compressing the springs 40; due to the outer member 38 and the inner member 39 slipping relative to each other, engagement of the one-way clutch 36 is released, and movement of the connecting rod 33 is not transmitted to the output shaft 13.

In this way, since, while the input shaft 12 rotates once, rotation of the input shaft 12 is transmitted to the output shaft 13 only for a predetermined time, if the input shaft 12 rotates continuously, the output shaft 13 rotates intermittently. Since the phases in the direction of eccentricity of the eccentric disks 19 of the six transmission units 14 are displaced from each other by 60°, the six transmission units 14 transmit rotation of the input shaft 12 to the output shaft 13 in turn, and the output shaft 13 rotates continuously.

In this process, the larger the amount of eccentricity ε of the eccentric disk 19, the larger the back-and-forth stroke of the connecting rod 33 becomes, the rotational angle of the output shaft 13 per cycle increases, and the gear ratio of the continuously variable transmission T becomes small. On the other hand, the smaller the amount of eccentricity ε of the eccentric disk 19, the smaller the back-and-forth stroke of the connecting rod 33 becomes, the rotational angle of the output shaft 13 per cycle decreases, and the gear ratio of the continuously variable transmission T becomes large. When the amount of eccentricity ε of the eccentric disk 19 becomes zero, even if the input shaft 12 rotates, the connecting rod 33 stops moving, the output shaft 13 therefore does not rotate, and the gear ratio of the continuously variable transmission T becomes UD, which is the maximum (infinite).

When the transmission shaft 15 does not rotate relative to the input shaft 12, that is, when the input shaft 12 and the transmission shaft 15 rotate at the same speed, the gear ratio of the continuously variable transmission T is held constant. In order to rotate the input shaft 12 and the transmission shaft 15 at the same speed, the electric motor 24 may be rotated at the same speed as that of the input shaft 12. The reason therefor is that the first ring gear 30 of the planetary gear mechanism 25 is connected to the input shaft 12 and rotates at the same speed as that of the input shaft 12; when the electric motor 24 is driven at the same speed as above, the sun gear 28 and the first ring gear 30 rotate at the same speed, the planetary gear mechanism 25 thereby attains a locked state, and the entirety rotates as a unit. As a result, the input shaft 12 and the transmission shaft 15 connected to the first ring gear 30 and the second ring gear 31, which rotate as a unit, are integrated and rotate at the same speed without rotating relative to each other.

When the rotational speed of the electric motor 24 is increased or decreased relative to the rotational speed of the input shaft 12, since the first ring gear 30 joined to the input shaft 12 and the sun gear 28 connected to the electric motor 24 rotate relative to each other, the carrier 27 rotates relative to the first ring gear 30. In this process, since the gear ratio of the first ring gear 30 and the first pinion 29a, which mesh with each other, is slightly different from the gear ratio of the second ring gear 31 and the second pinion 29b, which mesh with each other, the input shaft 12 connected to the first ring gear 30 rotates relative to the transmission shaft 15 connected to the second ring gear 31.

In this way, when the transmission shaft 15 rotates relative to the input shaft 12, the eccentric recess portions 19a and 19a of the eccentric disk 19 having the ring gear 19b meshing with the pinion 17 of each transmission unit 14 are guided by the guide portions 18a and 18a of the eccentric cam 18, which is integral with the input shaft 12, and rotate, and the amount of eccentricity ε of the center O2 of the eccentric disk 19 with respect to the axis L of the input shaft 12 changes.

FIG. 7(A) shows a state in which the gear ratio is a minimum (gear ratio: OD); here, the amount of eccentricity ε of the center O2 of the eccentric disk 19 with respect to the axis L of the input shaft 12 becomes a maximum value of 2d, which is equal to the sum of the distance d from the axis L of the input shaft 12 to the center O1 of the eccentric cam 18 and the distance d from the center O1 of the eccentric cam 18 to the center O2 of the eccentric disk 19. When the transmission shaft 15 rotates relative to the input shaft 12, the eccentric disk 19 rotates relative to the eccentric cam 18, which is integral with the input shaft 12, as shown in FIG. 7(B) and FIG. 7(C) the amount of eccentricity ε of the center O2 of the eccentric disk 19 with respect to the axis L of the input shaft 12 gradually decreases from a maximum value of 2d, and the gear ratio increases. When the transmission shaft 15 rotates further relative to the input shaft 12, the eccentric disk 19 rotates further relative to the eccentric cam 18, which is integral with the input shaft 12, as shown in FIG. 7(D) the center O2 of the eccentric disk 19 finally overlaps the axis L of the input shaft 12, the amount of eccentricity ε becomes zero, the gear ratio attains a maximum (infinite) state (gear ratio: UD), and power transmission to the output shaft 13 is cut off.

Since the continuously variable transmission T having the above arrangement has the one-way clutches 36 disposed between the connecting rod 33 and the output shaft 13, it is not possible to transmit the driving force from the output shaft 13 side back to the input shaft 12 side to thus operate engine braking. Therefore, the power transmission device of the present embodiment is provided with an auxiliary power transmission device (not illustrated) in order to make engine braking possible. The auxiliary power transmission device is for example one in which the input shaft 12 and the output shaft 13 are connected by means of an endless chain, and a one-way clutch is provided on the output shaft side, the one-way clutch being disengaged when traveling by means of the driving force of the engine E and being engaged when engine braking is operated.

In the present embodiment, deceleration fuel cut-off is carried out when the vehicle is decelerating, and when recovering from deceleration fuel cut-off and restarting the engine E, cranking of the engine E by means of the starter motor S and cranking of the engine E by means of the shift actuator 23 are selectively carried out.

Cranking of the engine E by means of the shift actuator 23 is first explained.

When the gear ratio is UD, the first engagement portion 43a of the first connecting member 43, which is integrated with the input shaft 12, and the second engagement portion 44a of the second connecting member 44, which is integrated with the gear shaft 15, abut against each other (see FIG. 9(A)). The first connecting member 43 integrated with the input shaft 12 stops when the engine E stops, and when in this state the electric motor 24 is driven in one direction, the first ring gear 30 and the second ring gear 31 are rotated relative to each other by means of the planetary gear mechanism 25 of the shift actuator 23. Since the first connecting member 43, which is integral with the first ring gear 30, is connected to the input shaft 12 and stopped, the second connecting member 44 integrated with the second ring gear 31 rotates in the clockwise direction in the figure relative to the first connecting member 43, and the gear ratio changes toward OD (see FIG. 9(B)). That is, when the gear ratio changes between UD and OD, the second engagement portion 44a of the second connecting member 44 does not press the first engagement portion 43a of the first connecting member 43.

When the electric motor 24 is driven in a direction opposite to the above when the engine E is stopped, the second connecting member 44 rotates in the counterclockwise direction in the figure with respect to the first connecting member 43, which is stopped, the second engagement portion 44a of the second connecting member 44 presses the first engagement portion 43a of the first connecting member 43, and the first connecting member 43 and the second connecting member 44 thereby rotate in the counterclockwise direction in the figure (see FIG. 9(C)). As a result, the input shaft 12 connected to the first connecting member 43 rotates, and the crankshaft of the engine E connected to the input shaft 12 can be cranked.

A case where the engine E is stopped (when the input shaft 12 is stopped) is explained above, but in a case where the engine E is running, increasing or decreasing the rotational speed of the electric motor 24 with reference to the engine rotational speed also enables the first connecting member 43 and the second connecting member 44 to be rotated relative to each other in any direction.

Furthermore, since the shift actuator 23 includes the tandem type planetary gear mechanism 25 sharing the integrated double pinions 29, the first engagement portion 43a is provided on the first connecting member 43 connecting the first ring gear 30 and the input shaft 12, and the second engagement portion 44a is provided on the second connecting member 44 connecting the second ring gear 31 and the gear shaft 15, it is possible to enhance the degree of freedom in setting the relative rotational angle between the first and second members 43 and 44 by means of the differential function of the planetary gear mechanism 25.

Moreover, since the first engagement portion 43a and the second engagement portion 44a engage with each other when the gear ratio is UD, the gear ratio is maintained at infinity while the engine E is started by cranking by means of the driving force of the electric motor 24, the friction of each sliding part of the continuously variable transmission T is minimized, and not only does the load of the electric motor 24 reduce, but also the driving force of the electric motor 24 is prevented from being outputted to the output shaft 13.

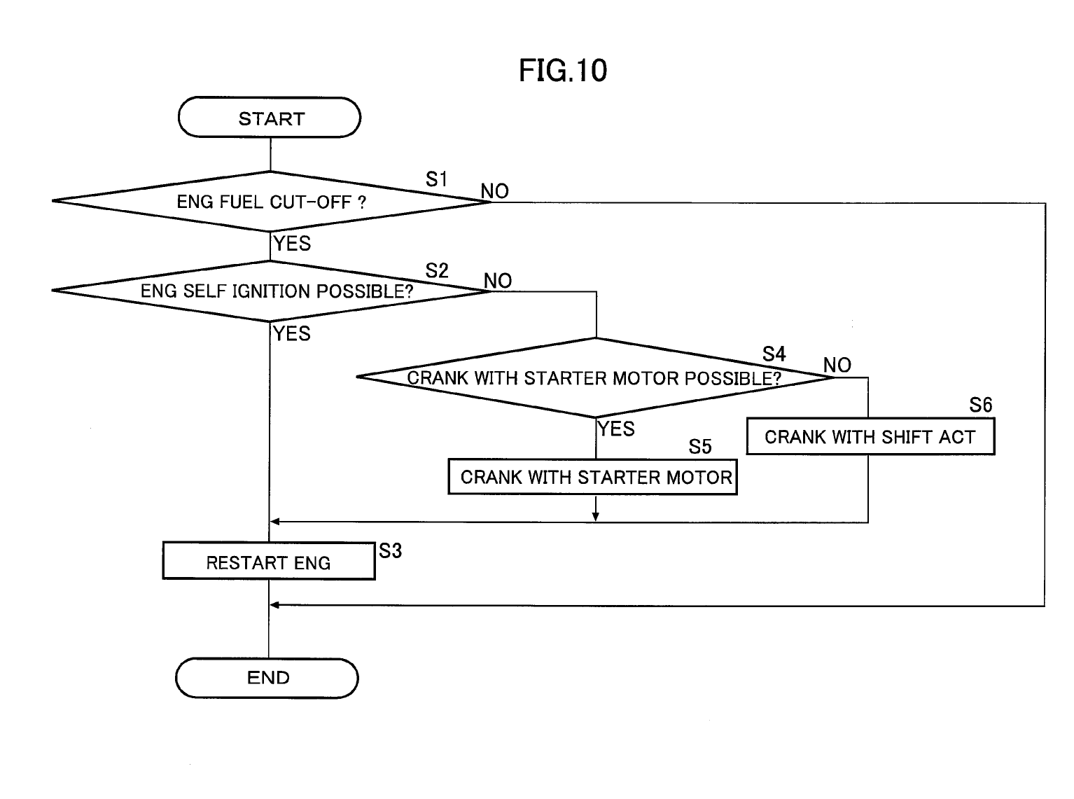

Restarting of the engine E when recovering from deceleration fuel cut-off is now explained by reference to the flowchart of FIG. 10.

When in step S1 the engine E is in a deceleration fuel cut-off state, if in step S2 due to the vehicle speed being relatively high the engine rotational speed is at least a lower limit of rotational speed at which self-ignition of the engine E is possible (second rotational speed), then in step S3 the engine E can be restarted simply by restarting the supply of fuel to the engine E without driving either the starter motor S or the shift actuator 23.

When in step S2 above the engine rotational speed is less than the lower limit of rotational speed at which self-ignition of the engine E is possible and restarting is not possible simply by restarting the supply of fuel to the engine E, in step S4 the engine rotational speed is compared with an upper limit of rotational speed at which plunging of the starter motor S is possible (first rotational speed). When the engine rotational speed is high, the pinion of the starter motor S cannot plunge into the ring gear, and the upper limit of rotational speed at which plunging is possible becomes the upper limit of rotational speed at which the pinion can plunge into the ring gear. Therefore, if in step S4 above due to the vehicle speed being relatively low the engine rotational speed is less than the upper limit of rotational speed at which plunging is possible, then in step S5 the engine E is restarted by driving the starter motor S to thus crank the engine E as well as restarting the supply of fuel in step S3 above.

If in step S2 above the engine rotational speed is less than the lower limit of rotational speed at which self-ignition is possible and in step S4 above the engine rotational speed is at least the upper limit of rotational speed at which plunging is possible, since neither restarting with self-ignition nor restarting with the starter motor S are possible, in step S6 the electric motor 24 of the shift actuator 23 is driven so as to increase the engine rotational speed to at least the lower limit of rotational speed at which self-ignition is possible, and in step S3 above the engine E is restarted by restarting the supply of fuel.

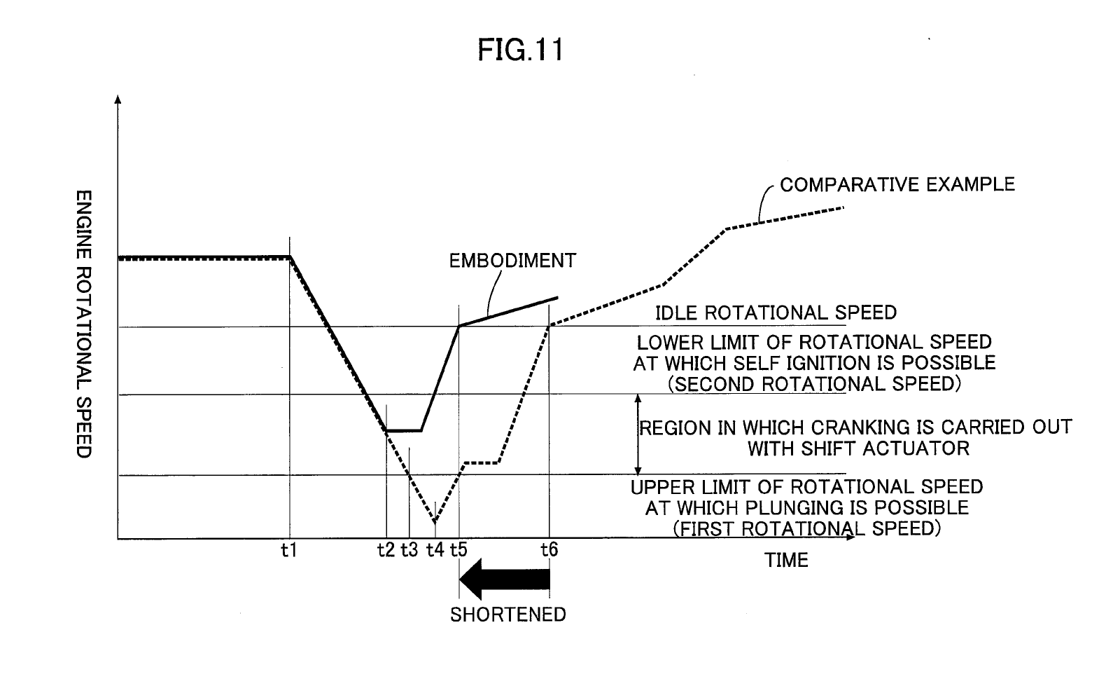

The operation is further explained by reference to the time chart of FIG. 11.

The broken line shows a Comparative Example in which restarting of the engine with the shift actuator 23 is not carried out; at time t1 a driver lifts off an accelerator pedal, the vehicle starts to decelerate, deceleration fuel cut-off is carried out, and the engine rotational speed decreases accompanying the decrease in vehicle speed. At time t2 the driver presses on the accelerator pedal in order to accelerate the vehicle; since the engine rotational speed is less than the lower limit of rotational speed at which self-ignition is possible, the engine E cannot be restarted simply by starting the supply of fuel, and since the engine rotational speed is at least the upper limit of rotational speed at which plunging is possible, restarting of the engine E with the starter motor S is also not possible.

Because of this, the starter motor S is driven by waiting for the engine rotational speed to become less than the upper limit of rotational speed at which plunging is possible at time t3, and when at time t4 the pinion of the starter motor S plunges into the ring gear, cranking of the engine E with the starter motor S finally becomes possible. At time t6 the engine rotational speed reaches idle rotational speed, and the engine E attains a complete combustion state to thus complete restarting.

On the other hand, the solid line shows an embodiment in which restarting of the engine E with the shift actuator 23 is carried out; at time t1 the driver lifts off the accelerator pedal, the vehicle starts decelerating, deceleration fuel cut-off is carried out, and the engine rotational speed decreases accompanying the decrease in vehicle speed. At time t2 the driver presses on the accelerator pedal in order to accelerate the vehicle, the electric motor 24 of the shift actuator 23 immediately operates, the engine rotational speed turns upward by virtue of the driving force thereof, at time t5 the engine rotational speed reaches the idle rotational speed, and the engine E attains a complete combustion state to thus complete restarting.

As described above, in the Comparative Example at time t6 restarting of the engine E is completed, but in the present embodiment restarting of the engine E can be completed at time t5, which is earlier than time t6, and the driver can accelerate the vehicle without experiencing a time lag. Moreover, since the electric motor 24 of the shift actuator 23 need only have an output that can increase the rotational speed of the engine E, the electric motor 24 can be made small.

An embodiment of the present invention is explained above, but the present invention may be modified in a variety of ways as long as the modifications do not depart from the spirit and scope thereof.

For example, since the shift actuator of the present invention may be formed using any type of reduction mechanism, it is not limited to one in which the planetary gear mechanism 25 of the embodiment is used, and it may be one in which a hypocycloid mechanism is used or one in which a wave gear mechanism such as a Harmonic Drive (registered trademark) is used.

Furthermore, in the embodiment the outer peripheral part of the first connecting member 43 and the outer peripheral part of the second connecting member 44 are provided with the first engagement portion 43a and the second engagement portion 44a respectively, but a first engagement portion 43a and a second engagement portion 44a may be provided at any position of a first connecting member 43 and a second connecting member 44.

Moreover, the members on which the first engagement portion and the second engagement portion are provided are not limited to the first connecting member 43 and the second connecting member 44; they may be two members that undergo relative movement according to a change in the gear ratio and, for example, a first engagement portion and a second engagement portion may be provided on two eccentric disks 19 and 19 that are adjacent in the axial direction.

Furthermore, in the embodiment the first engagement portion 43a and the second engagement portion 44a are engaged when the gear ratio is UD, but a first engagement portion 43a and a second engagement portion 44a may be engaged after the gear ratio increases from the OD side and exceeds UD. By so doing, even if the gear ratio changes between UD and OD while the vehicle is traveling, the first engagement portion 43a and the second engagement portion 44a are prevented from being engaged, and it is possible to prevent the gear ratio from being changed unintentionally or the occurrence of shock.

1. A vehicular power transmission device comprising
an input shaft that is connected to an engine having a plunge type starter motor,
an output shaft that is disposed in parallel to the input shaft,
a swinging link that is swingably supported on the output shaft,
a one-way clutch that is disposed between the output shaft and the swinging link, and that is engaged when the swinging link swings in one direction, and that releases engagement when the swinging link swings in the other direction,
an eccentric member that rotates eccentrically integrally with the input shaft,
a gear shaft that is disposed coaxially with the input shaft and changes an amount of eccentricity of the eccentric member,
a shift actuator that makes the gear shaft rotate relative to the input shaft,
an electric motor that drives the shift actuator, and
a connecting rod that connects the eccentric member and the swinging link, wherein
the shift actuator comprises a first member that is connected to the input shaft, a second member that is connected to the gear shaft, a third member that is connected to the electric motor and that drives the first and second members at different rotational speeds, and engagement portions that engage with each other when the first and second members are in a predetermined phase and that are capable of transmitting rotation of the second member directly to the first member,
when the rotational speed of the engine during deceleration fuel cut-off is less than a first rotational speed, which is an upper limit of rotational speed at which plunging of the starter motor is possible, the engine is restarted by driving the starter motor,
when the rotational speed of the engine during deceleration fuel cut-off is at least a second rotational speed, which is a lower limit of rotational speed at which self-ignition of the engine is possible, the engine is restarted by restarting fuel injection, and
when the rotational speed of the engine during deceleration fuel cut-off is at least the first rotational speed but less than the second rotational speed, the engine is restarted by transmitting the driving force of the electric motor to the input shaft via the engagement portion.

2. The vehicular power transmission device according to claim 1, wherein when the rotational speed of the engine during deceleration fuel cut-off is at least the first rotational speed but less than the second rotational speed, the rotational speed of the engine is increased to at least the second rotational speed by the driving force of the electric motor.

3. The vehicular power transmission device according to claim 1, wherein the amount of eccentricity of the eccentric member when the engagement portion engages is zero.

4. The vehicular power transmission device according to claim 2, wherein the amount of eccentricity of the eccentric member when the engagement portion engages is zero.
